(19) United States
(12) Patent Application Publication
(10) Pub. No.: US 2002/0131060 A1
(43) Pub. Date: Sep. 19, 2002

(54) Process and apparatus for the digital production of a picture

(76) Inventors: Michael Maier, Zurich (CH); Hans Gerber, Suhr (CH)

Correspondence Address: Patrick C. Keane, BURNS, DOANE, SWECKER & MATHIS, L.L.P., P.O. Box 1404, Alexandria, VA, 22313-1404, US

(21) Appl. No.: 10/090,167

(22) Filed: Mar. 5, 2002

(30) Foreign Application Priority Data
Mar. 6, 2001 (EP) 01 104 591.1

(51) Int. Cl. G06K 1/00; G06F 15/00

(52) U.S. Cl. 358/1.2; 358/1.18

(57) ABSTRACT

For the production of a photographic picture from an original image image (V) present in electronic form, the digital image data of the original image are recorded, especially exposed, onto a sheet type picture carrier (P) by way of a digital recording arrangement. The picture carrier is thereby located in recording position on a recording platform (10). During the positioning of the picture carrier (P) on the recording platform the picture carrier is measured with respect to size and position relative to the recording platform (10) by a photoelectric scanning device (21). A position and size correction is carried out on the basis of the thereby obtained measurement data. In the case of a photographic recording, this correction can be carried out by a corresponding adjustment of the projection optics. Alternatively, the image data of the original image image (V) are transformed by calculation and only the transformed image data are recorded on the picture carrier (P). The transformation of the image data consists essentially of an image shift and possibly an adaptation of the image size and, if required, an image rotation. Size variations and positioning errors of the picture carrier can be captured by the measuring of the picture carrier (P) on the recording platform (10) and the correction of the position and size depending on the data determined during the measurement, and the image to be reproduced can be optimally recorded on the picture carrier within the conventional tolerances.

### FIELD OF THE INVENTION

The invention relates to a process and apparatus for the digital production of a picture from an original image, which is present in electronic form, by pixel-by-pixel recording of the image information of the original image onto a sheet type picture carrier.

### BACKGROUND ART

Digital image reproducing apparatus on a photographic basis, so called digital photographic printers, produce pictures or copies by exposing the image information of the underlying original image which is present in electronic format, onto a photosensitive copier material. One possibility is the optical reproduction of the image information of the original image by a suitable electro-optical converter device operating pixel-by-pixel, thereby producing an optical representation of the original image, and projecting this optical representation of the original image onto the copier material for exposure thereonto. Suitable electro-optical converter devices are thereby active (self-illuminated) as well as passive (modulating) electro-optical arrangements; typical examples being cathode ray tubes, liquid crystal cell arrays operating in transmission or reflection, light emitting diode cell arrays, electro-luminescence cell arrays, and lately also so-called digital micro mirror arrays.

Other digital image reproducing apparatus use color printers, generally ink-jet printers. The digital image information of the underlying original image is thereby recorded pixel-by-pixel (printed) onto a picture carrier material by way of several printing heads which most of the time are respectively provided with several printing nozzles.

A widely distributed type of digital image reproducing apparatus (for example so-called digital minilabs) is adapted for the processing of picture carrier material in the form of individual sheets. The recording material is thereby generally stored on a roller from which individual sheets of the respectively required length are cut and transported onto a recording platform, whereon the digital image recording is then carried out - by printing or by photographic exposure.

The precise positioning of the sheets on the recording platform is a challenge in the processing of sheet material. After cutting, the sheets are normally transported from the roller by way of conveyor belts or similar transport devices along a linear transport path to the recording platform and oriented thereon in a pre-defined recording position. While positioning in longitudinal direction (which means the transport direction) is generally achievable with sufficient precision, lateral deviations transverse to the transport direction often result during transport of the sheet material. Furthermore, (mostly minor) rotation of the sheet material can occur, so that the edges of the rectangular sheet material no longer extend exactly parallel or perpendicular to the transport direction. It is a further challenge that the width of the sheet material in practice is always subject to certain variations (deviations from the nominal value). For example, according to generally accepted standards for recording material it is permitted for the nominal width of 10.2 cm to have a variation of +/−0.2 mm.

For the picture production, one distinguishes between frameless pictures and pictures with a frame. For frameless pictures, the effective picture size (which means the region of the recording material covered by image information) ideally exactly corresponds to the sheet size of the recording material. However, due to unavoidable tolerances—see above—the picture size is in practice selected marginally larger, whereby an edge overhang of maximally 0.30 mm is generally considered acceptable. For pictures with frame, the effective image size must of course be smaller than the sheet size, by the size of the frame. In that case, generally even smaller tolerances apply—only a maximum (linear) deviation of +/−0.1 mm is considered permissible. To achieve the mentioned tolerance limits, the sheet material must be positioned correspondingly precisely on the recording platform, which is not always possible for the above mentioned reasons or is only possible at significant cost.

### SUMMARY OF THE INVENTION

It is now an object of the present invention to overcome these difficulties and to improve a process and apparatus of the generic type in such a way that both frameless pictures as well as pictures with frame can be produced within the mentioned tolerance limits.

This object is achieved in accordance with the invention by measuring the size and position of the picture carrier relative to the recording platform during the positioning thereof on the recording platform, and subsequently carrying out a positioning and size correction on the basis of the measured data obtained, so that the picture to be produced optimally fits onto the picture carrier. The position and size correction is preferably carried out in the case of a photographic recording by corresponding adjustment of a projection lens or by transformation (recalculation) of the image data of the original image or possibly also by a combining both measures. The transformation of the image data preferably includes an image shift, optionally a size adaptation and optionally also an image rotation. In the simplest case, an image shift corresponding to the positioning error of the picture carrier on the recording platform is sufficient, possibly in combination with an adaptation of the image size to the actual width of the picture carrier. An image rotation can normally be omitted, since the rotation errors which occur in practice are negligible according to experience.

### BRIEF DESCRIPTION OF THE DRAWINGS

The invention will now be further described by way of example only and with reference to the accompanying drawing, wherein

FIG. 1 is a schematic of an exemplary embodiment of the apparatus in accordance with the invention;

FIGS. 2 and 3 are two schematics illustrating the scanning of an picture carrier;

FIG. 4 is a schematic illustrating the calculation of measured data;

FIG. 5 is a block diagram of the process in accordance with the invention; and

FIG. 6 is a principal schematic illustrating the construction of a scanning device.

### Detailed DESCRIPTION OF THE PREFERRED EMBODIMENT

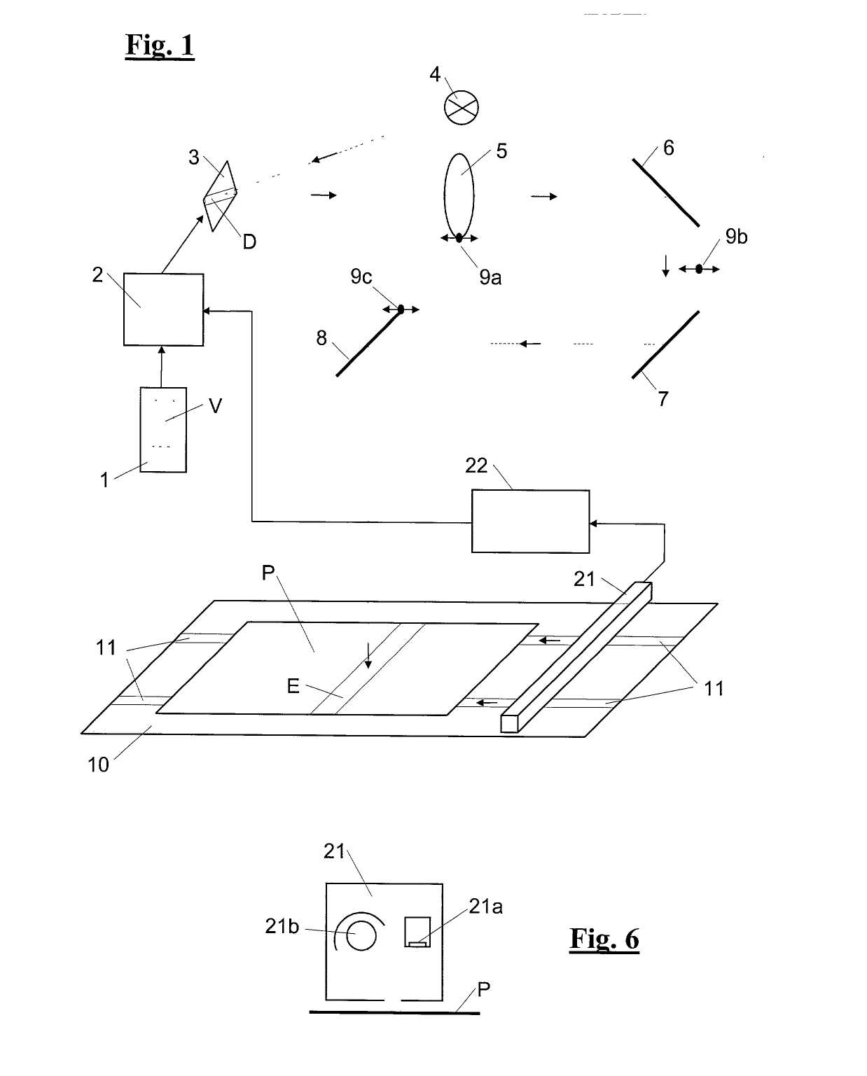

FIG. 1 shows a principle schematic of an exemplary embodiment of the apparatus in accordance with the invention. The apparatus includes a memory 1, a control 2 an illumination source 4, an electro-optical converter device 3 operating pixel-by-pixel and in the form of a micro mirror array, projection and/or imaging optics including a lens 5 and three redirecting mirrors 6, 7 and 8, and drive means for the redirecting mirrors and the lens symbolized by arrows 9a-9c. The apparatus further includes a recording platform 10 on which a sheet P of a photographic copier material is positioned in the recording position. Two conveyor belts 11 are indicated at the recording platform 10, which are driven in a generally known manner by a motor (not illustrated), and by which the sheet P (from the right side of the drawing) is transported in a known manner on the recording platform 10 into the recording position, or can again be removed therefrom (in the drawing towards the left).

The original image from which a physical picture or copy is to be produced is present in electronic form. The image information of the original image V, which is comprised of the totality of all brightness and color information for each individual image point of the original image V to be copied, is thereby present in the memory 1, from which it can be recalled pixel-by-pixel by way of the control 2 and possibly separated by color portions.

The two redirecting mirrors 6 and 7 are stationary relative to one another and are positioned at a right angle to one another so that they redirect the beam path by 180°. The redirecting mirror 8 is always in parallel to the redirecting mirror 7 and redirects the beam path by 90° onto the sheet P of the photographic copier material positioned on the recording platform. The redirecting mirror 8 moves in the same direction as the two redirecting mirrors 6 and 7, but at twice the speed, so that the optical distance between the lens 5 and the sheet P remains constant independent of the position of the redirecting mirrors. A strip shaped illumination area D is moved across the (stationary) sheet P of copier material by movement of the redirecting mirrors in the described manner. The reproduction scale can be changed by minor adjustment of the lens 5 together with a corresponding adjustment of the redirecting mirrors 6-8.

The control 2 recalls the image information of a first strip shaped portion of the original image V and controls the electro-optical converter device 3 therewith, which converter operates pixel-by-pixel and produces a reproduction of the strip shaped portion in the form of an image by way of the signals fed thereto. The electro-optical converter device 3 can have a rectangular arrangement of, for example, 1280×1024 individual mirrors, of which, for example, only 1280 ×300 or—in the illustrated diagonal position—only 1919×192 are used for the image reproduction. However, it can also be formed, for example, by a light emitting diode array with a corresponding number of individual diodes. The optical representation of the strip shaped portion of the original image V reproduced by the electro-optical converter device 3—also in the form of a strip—is now projected by way of the projection and/or imaging optics 5-8 in the strip shaped illumination region E onto the sheet P of copier material positioned on the reproduction platform 10 and thereby exposed thereonto. Subsequently, a further strip shaped portion is recalled, an optical representation produced therefrom and the latter exposed onto the sheet P in an illumination region advanced by a corresponding distance. The whole is repeated until the complete original image has been captured and the last strip shaped portion of the original image was recalled and an optical representation produced therefrom and exposed onto the sheet P of copier material.

The strip shaped portions of the original image are not seamlessly positioned side by side, but overlap to a large degree (transverse to the longitudinal direction). This leads to the strips projected onto the sheet P overlapping as well, so that the sheet P is also multiply exposed, depending on the degree of overlap. This multiple exposure is taking into consideration by correspondingly lowering (possibly selectively by color) with the control 2 the brightness values of the individual image points of the optical representation of the portions so that the sum total amount of copier light projected onto the copier material at the respective image points is again correct. This exposure method is known under the term TIG (time integration gray scale).

So far, the apparatus completely corresponds in construction and function to the apparatus described, for example, in EP-A-0 986 243 and therefore does not need to be further described.

As already mentioned, it is required for a strip-wise projection that a relative movement is carried out between the strip-shaped illumination region E and the copier material sheet P. This is achieved in the present exemplary embodiment by movement of the lens 5 and the redirecting mirrors 6-8. Alternatively, a relative movement can of course also be achieved by a corresponding advance of the copier material sheet P.

In place of the micro-mirror array 3 and the associated projection optics 5-8, any other digital optical illumination arrangement which operates pixel-by-pixel can be used. Examples herefor are, as already mentioned, cathode ray tubes, light emitting diode arrays, electroluminescence arrays, or liquid crystal arrays. Finally, the image reproduction can in principle also be carried out by printing with a color printer suitable for these purposes, whereby the image information of the original image V would be fed to the printer by the control 2 or the control would be a component of the printer and the printing heads of the printer would be moved relative to the sheet P of recording material positioned on the recording platform.

For reasons of brevity, individual sheets P of recording material are in the following referred to as paper. Correspondingly, the recording platform 10 is referred to as paper platform. All descriptions are applicable independent of the image recording technology respectively used, which means equally for digital photographic exposure and for digital printing.

According to the most preferred embodiment of the invention, the paper P is measured on the paper platform 10 and the recording of the image information controlled on the basis of the thereby obtained measured data. For that purpose, the image reproduction apparatus in accordance with the invention is provided at the input side of the paper platform 10 with a further electrical scanning device 21 and with a position processor 22 cooperating therewith, which in turn is connected with the control 2 and provides the latter with the actual measured data of the paper P on the paper platform 10.

The scanning device 21 extends over the whole width of the paper platform 10 at a small distance thereabove and consists essentially of a linear arrangement of photoelectric converter elements as well as an illumination arrangement extending also over the whole width of the paper platform. The photoelectric converter elements are preferably constructed as a linear CCD field (charge coupled devices), as used, for example, in line scanners (scanners). The local resolution of the converter element arrangement can be, for example, 300 dpi (corresponding to 300 elements per 2.54 cm) which for a total length of, for example, about 25 cm results in a total of about 3000 converter elements. The illumination arrangement can be constructed as an elongated rod shaped light source. The principle construction of the scanning device 21 is apparent from the schematical illustration of FIG. 6. The illumination arrangement is therein labeled with 21 B, the arrangement of the photoelectric converter elements with 21A.

On its path from the roller from which it is cut to the recording position on the paper platform 10 the paper P moves under and past the scanning device 21 and is line by line photoelectrically scanned thereby. It is thus exposed to light from the illumination arrangement of the scanning device 21 and the light remitted from the paper P or from the paper platform 10 beyond the paper P is captured by the photoelectric converter elements of the scanning device 21 and converted into corresponding electrical signals. The latter are read out line by line by the position processor 22 and analyzed for the calculation of the measured data of interest of the paper P on the paper platform 10. If the paper P is made of photographic material, non-actinic light is of course used for the illumination, typically infrared in the non-actinic range.

Scanning devices of the type used herein as well as their electrical control are generally known, for example, from scanners operating line by line or from office copier apparatus or also from the DE-A19858968(priority U.S. 006565 of Jan. 14, 1998), so that the person skilled in the art does not need any further explanation in relation thereto. For the comprehension of the present invention it is simply important to remember that the signal produced by a single converter element clearly differs depending on whether or not paper P is located under the converter element. Thus, a limit edge of the paper P can be recognized on the basis of the signal level difference between neighboring converter elements, and its position (in longitudinal direction of the converter arrangement) can be determined. The position is thereby measured in pixel units of the converter arrangement, which means at the resolution of the converter arrangement. Since the scanning device 21 is in a fixed spatial relation to the paper platform 10, the position (measured in longitudinal direction of the converter arrangement) of a recognized paper edge relative to the paper platform 10 is known.

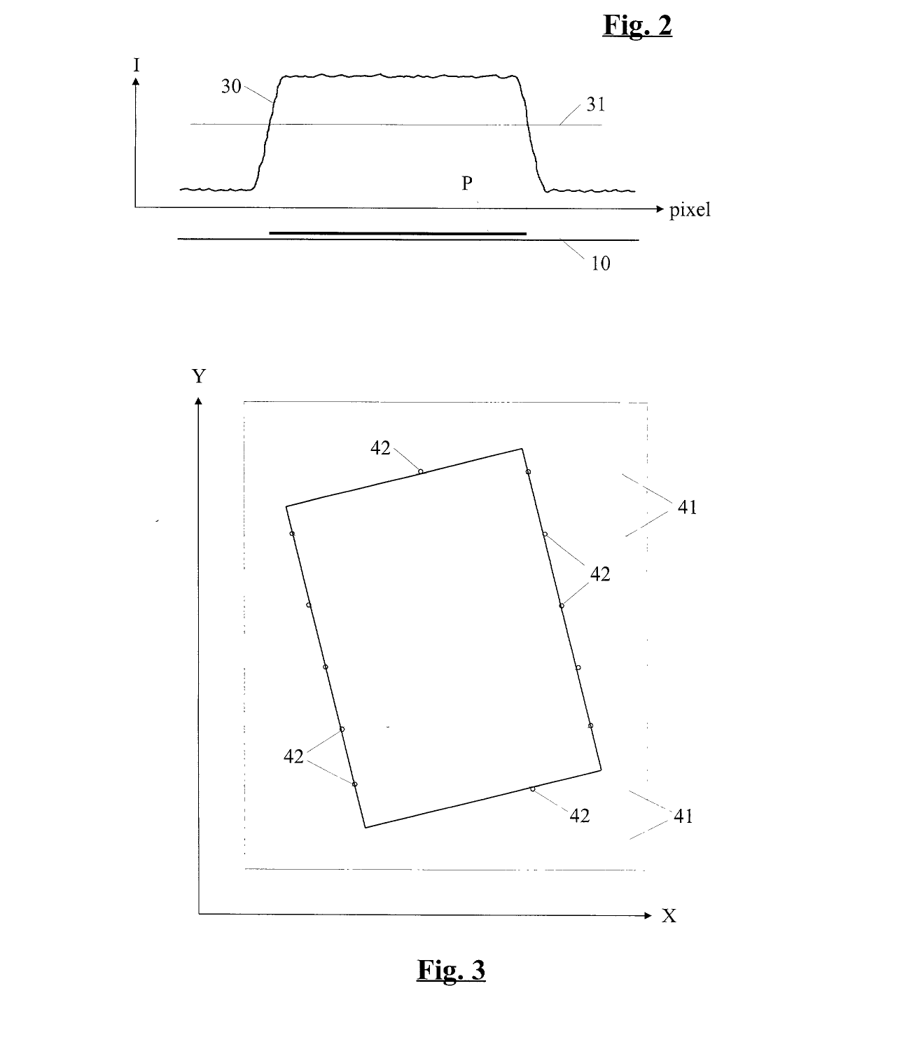

FIG. 2 details the principle of the paper edge capture. It shows a typical signal curve 30 (illustrated somewhat idealized) along a scanning line, which means the signal levels produced by the individual converter elements of the scanning device 21 during the scanning of one line. The abscissa shows the individual converter elements of the scanning device, the ordinate the intensity of the signals produced by the converter elements. In the region of the two limiting edges of the paper P, the signal level respectively suddenly changes within a normally limited transition region (a few neighboring converter elements). Those converter elements at which the signal level is for the first time or the last time above a threshold value 31 define (for the respective scanning line) the position of the limiting edges of the paper P. The threshold value 31 was of course previously determined by way of several test measurements.

The cartesic coordinate system is used for the calculation of the measured data of the paper P, whereby the coordinate origin lies, for example, in the center of the paper platform 10 and the two orthogonal coordinate axes X and Y are placed parallel or perpendicular to the (ideal) transport direction of the paper P, so that the longitudinal direction of the scanning device 21 lies parallel to the X axis. The converter elements of the scanning device 21 thereby capture the position of the paper in the X direction. The respective position of the paper P in Y direction is given by the increment of advance of the paper transport. It is furthermore required that during transport of the paper P along the relatively short distance from the scanning device 21 to the recording position (normally centered on the paper platform) position errors no longer occur. This prerequisite is achievable in practice with the conventional transport devices with sufficient precision.

A sheet of paper P (coming from the right of the drawing) is placed on the platform 10 and transported under the scanning device 21 to the recording position. The leading edge of the paper P entering onto the platform 10 is thus captured in a generally known manner by way of separate optical or mechanical sensors and the paper is then transported further by a distance corresponding to its (nominal) length and dimensions of the paper platform 10. Instead of separate sensors, the scanning device 21 itself can also be used for the capturing of the leading edge of the paper. As soon as the paper is located under the scanning device 21, it is scanned line by line for each increment of advance and the associated scanning data are stored in the position processor 22. This is repeated until the whole sheet of paper P was passed under the scanning device 21 and scanned.

The position processor 22 determines from the stored scanning data in each scanning line the position (X coordinates) of the paper edges or edge points as described with reference to FIG. 2. The associated Y coordinate of the edge points is given by the respective scanning line itself. The entirety of the X and Y coordinates of the edge points determined in this way represents the outline of the sheet of paper defined by the paper edges. This is apparent from FIG. 3. A few arbitrarily selected scanning lines are therein labeled with 41 and the reference numbers 42 define the edge points of the scanned sheet of paper associated with the respective scanning lines.

Since the paper P on the paper platform 10 is transported (in Y direction) from that position at which its entry onto the paper platform is captured (separate sensors or scanning device 21—see above) and for a rigidly preset distance (depending on the nominal sheet length and the connections of the paper platform), the Y coordinates of the edge points 42 have a fixed relationship (constant offset) to the coordinate origin in the center of the paper platform. For the following, it is presumed that the Y coordinates of the edge points in the position processor 22 have already been corrected (coordinates shift) by the fixed distance (offset), so that the center of an error-free-positioned sheet of paper P having the nominal length and width coincides with the coordinate origin (center of the paper platform).

When the sheet of paper P has dimensions (length, width) deviating from the nominal values and/or when positioning errors occur during transport of the paper onto the paper platform, the center of the sheet of paper P lies outside the coordinate origin, whereby its coordinates identifie the positioning error in X and/or Y direction. The position processor 22 now calculates the coordinates of the sheet center and the possible angle of rotation as well as the actual length and width of the sheet of paper P.

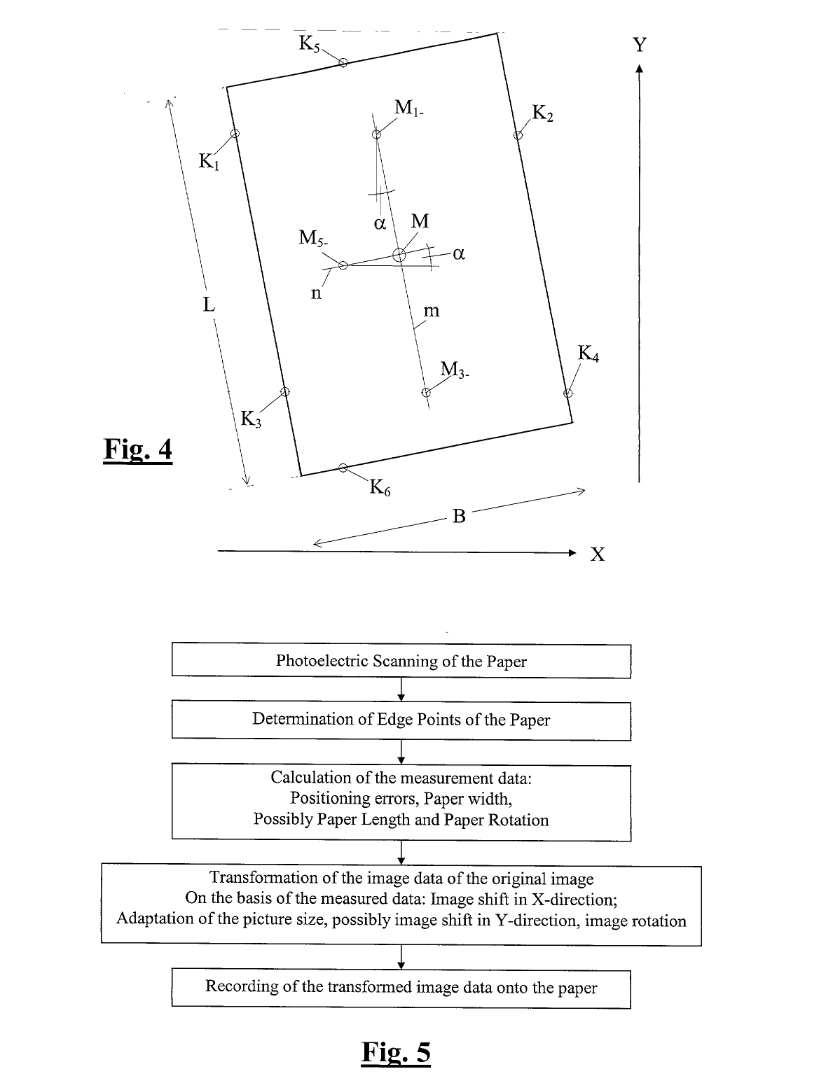

As is apparent from FIG. 4, the coordinates of (at least) 6 edge points K₁-K₆ of the scanned paper P are required for the calculation of the positioning error, the angle of rotation and the actual sheet measurements. It is thereby assumed that the paper is rectangular, which is always fulfilled in the practice with sufficient precision. The center of the paper is labeled M. Four edge points K₁-K₄ (with pairs of equal Y coordinates) on the two lateral edges and two edge points K₅-K₆ (with equal X coordinates) on the forward and rear edges of the paper P are preferably used for the calculation, but the opposite or any other constellation is thereby also possible.

In the interest of a calculation incorporating as few errors as possible, the edge points K₁-K₆ relied upon for the calculation are selected such that the two scanning lines to which the edge points K₁-K₄ belong are spaced apart as far as possible. However, at the same time, the edge points K1-K4 must have a sufficient safety distance from the forward or rear edge of the paper. Since the nominal paper size is known and the dimension variations of the paper as well as the positioning error to be expected are comparatively low, the selection of suitable scanning lines is simple.

The calculation of the measured data is carried out in a manner generally known according to the methods of the analytical geometry. Initially, the center points M₁₋₂, M₃₋₄ and M₅₋₆ between the edge points K1 and K2, K3 and K4, and K5 and K6 are determined. The straight line m is then determined which goes through the two center points M₁₋₂ and M₃₋₄. That straight line n is then determined which extends through the center point M₅₋₆ and is perpendicular to the straight line m which extends through the center points M₁₋₂ and M₃₋₄. Finally, the point of intersection of the two straight lines m and n is determined, which represents the center point M of the sheet of FIG. 2. The coordinates of the center point M show the position error Δx and Δy of the sheet of paper P in X and Y direction. The angle α by which the paper is rotated relative to the ideal position results, of course, from the slope of the straight-line n. The actual length L of the paper is calculated from the distance of the two edge points K₅ and K₆ multiplied by the cosign of the angle α. The actual width B of the paper is correspondingly calculated from the distance of the two edge points K₁ and K₂ or K₃ and K₄, multiplied by the cosign of the angle α.

The measured data formed because of the position errors ΔX and ΔY, the length L and the width B of the paper P, and the angle of the rotation α of the paper P are transferred by the positioning processor 22 to the control 2. The latter transforms the image data of the original image V positioned in the memory 1 on the basis of these measured data, so that the image to be reproduced is correctly recorded onto the paper. The transformation of the image data includes (in the extreme case) an image shift by the positioning error ΔX and ΔY, an image rotation by the angle of rotation αand an adaptation of the image size depending on the length L and width B of the paper. The transformation of the image data is carried out according to the known methods of the digital image processing and therefore does not need to be further explained for the person skilled in the art. The image shift in X direction as well as the size adaptation of the image to be recorded can also be carried out by a corresponding adjustment of the lens 5 and, if required, also the redirecting mirrors 6-8.

In practice, especially positioning error ΔX transverse to the transport direction of the paper P as well as variations in the paper width V dominate, according to experience. Positioning errors ΔY in transverse direction, deviations of the paper length L and rotation a of the paper can generally be neglected. Under those circumstances, the calculation of the measured data is of course significantly simplified, since only the positioning error ΔX and the width B of the paper still need to be determined. Theoretically, only two edge points which lie in the same scanning line on the two lateral edges of the paper are required for this calculation, while in practice, however, several edge points are used in an averaging is carried out. The required transformation of the image data of the original image V is correspondingly simplified, since only an image shift by the positioning error ΔX in X direction as well as an adaptation of the image size to the actual paper width B need be carried out. Again, the image shift and the image size adaptation can also be achieved by a corresponding adjustment of the lens 5 or, if required, the redirecting mirrors 6-8.

FIG. 5 again clearly illustrates the most important steps of the process in accordance with the invention in the for of a block diagram. The text in the individual blocks is self-evident and therefore does not require any further comments.

With the process in accordance with the invention and the corresponding apparatus in accordance with the invention, it is possible to produce pictures with frame as well as frameless pictures while maintaining the above mentioned tolerance limits for the image size and the image position on the paper.

1. Process for the production of a picture from an original image, which is present in electronic form, by pixel-by-pixel recording of the digital image data of the original image onto a sheet type picture carrier, which is transported onto a recording platform and positioned thereon, comprising the steps of
measuring the size and relative position of the picture carrier on the recording platform; and
carrying out a position and size correction on the basis of the measured data obtained by the measuring of the picture carrier, for recording of the digital image data of the original image onto the sheet type picture carrier.

2. Process according to claim 1, wherein the recording of the image data is carried out with a projection or imaging optics by exposure of the picture carrier, transverse positioning errors of the picture carrier transverse to the transport direction of the picture carrier relative to a nominal position on the recording platform are determined, and an image shift by the transverse positioning error is carried out through corresponding local adjustment of at least parts of the projection or imaging optics.

3. Process according to claim 2, comprising the further steps of determining the width of the picture carrier as measured transverse to the transport direction, and adaptation of the image size to the determined with of the picture carrier by corresponding adjustment of at least parts of the projection or imaging optics.

4. Process according to claim 1, wherein the digital image data of the original image are transformed by recalculation for the position and size correction by way of the measured data determined during measuring of the picture carrier, and the transformed image data of the original image are recorded onto the picture carrier.

5. Process according to claim 4, comprising the further steps of determining a transverse positioning error of the picture carrier transverse to the transport direction of the picture carrier relative to a nominal position on the recording platform, and carrying out an image shift by the transverse positioning error.

6. Process according to claim 4, comprising the further steps of determining the width of the picture carrier as measured transverse to the transport direction, and adapting the image size to the determined width of the picture carrier during transformation of the image data.

7. Process according to claim 4, comprising the further steps of determining the longitudinal positioning error of the picture carrier parallel to the transport direction of the picture carrier relative to a nominal position on the recording platform, and carrying out an image shift by the longitudinal positioning error during the transformation of the image data.

8. Process according to claim 4, comprising the further steps of determining the length of the picture carrier measured parallel to the transport direction, and carrying out an adaptation of the image size to the determined length of the picture carrier.

9. Process according to claim 4, comprising the further steps of determining an angle of rotation of the picture carrier relative to a nominal angular position on the recording platform, and carrying out an image rotation by the angle of rotation during the transformation of the image data.

10. Process according to claim 4, wherein the measurement of the picture carrier is carried out by way of a photoelectric scanning device positioned at the recording platform or in the immediate vicinity thereof.

11. Apparatus for the production of a picture from an original image, which is present in electronic form, by pixel-by-pixel recording of the digital image data of the original image onto a sheet type picture carrier, comprising
a memory for storage of the image data of the original image,
a recording platform on which the picture carrier can be positioned in a recording position, transport means for transporting the picture carrier on the recording platform,
a digital recording device for recording the image data of the original image onto the picture carrier positioned on the recording platform,
a photoelectric scanning device for the picture carrier located in the immediate vicinity of the recording platform,
a position processor cooperating with the scanning device, the scanning device and the position processor being constructed for measuring the size and relative position of the picture carrier on the recording platform and for determining corresponding measured data, and
a control cooperating with the position processor for carrying out a position and size correction on the basis of the measured data obtained during the measuring of the picture carrier, for the recording of the digital image data of the original image onto the sheet type picture carrier.

12. Apparatus according to claim 11, further comprising a projection or imaging optics for recording the image data by exposure, whereby the position processor is constructed for determining a transverse positioning error of the picture carrier transverse to its transport direction and relative to a nominal position on the recording platform, and the control is constructed for carrying out an image shift by the transverse positioning error by corresponding adjustment of at least parts of the projection or imaging optics.

13. Apparatus according to claim 12, the position processor being constructed for determining from the scanning signals produced by the scanning device the width of the picture carrier as measured transverse to the transport direction, and for adapting the image size to the determined with of the picture carrier by a corresponding adjustment of at least parts of the projection or imaging optics.

14. Apparatus according to claim 11, wherein the control is constructed for transforming by calculation the image data of the original image prior to recording on the picture carrier according to the measured data for carrying out a position and size correction.

15. Apparatus according to claim 11, wherein the scanning device is positioned in the transport path of the picture carrier on the recording platform and extends transverse to the recording platform.

16. Apparatus according to claim 15, the scanning device comprising
an illumination arrangement for exposure of the picture carrier with measuring light, and
a linear arrangement of photoelectric converter elements for receiving and converting the measuring light remitted from the picture carrier into electrical signals.

17. Apparatus according to claim 14, wherein the position processor is constructed for determining from the scanning signals produced by the scanning device a transverse positioning error of the picture carrier transverse to the transport direction of the picture carrier relative to a nominal position on the recording platform, and for carrying out an image shift by the transverse positioning error during transformation of the image data of the original image.

18. Apparatus according to claim 14, wherein the position processor is constructed for determining from the scanning signals produced by the scanning device a longitudinal positioning error of the picture carrier parallel to the transport direction of the picture carrier relative to a nominal position on the recording platform, and for carrying out an image shift by the longitudinal positioning error during transformation of the image data of the original image.

19. Apparatus according to claim 14, wherein the position processor is constructed for determining from the scanning signals produced by the scanning device the width of the picture carrier as measured transverse to the transport direction, and for carrying out an adaptation of the image size to the determined width of the picture carrier.

20. Apparatus according to claim 14, wherein the position processor is constructed for determining from the scanning signals produced by the scanning device the length of the picture carrier as measured parallel to the transport direction, and for carrying out an adaptation of the image size to the determined length of the picture carrier.

21. Apparatus according to claim 14, wherein the position processor is constructed for determining from the scanning signals produced by the scanning device an angle of rotation of the picture carrier relative to a nominal angular position on the recording platform, and for carrying out an image rotation by the angle of rotation during the transformation of the image data.
